(19) United States
(12) Patent Application Publication
(10) Pub. No.: US 2009/0164211 A1
(43) Pub. Date: Jun. 25, 2009

(54) SPEECH ENCODING APPARATUS AND SPEECH ENCODING METHOD

(75) Inventor: Toshiyuki Morii, Kanagawa (JP)

Correspondence Address: GREENBLUM & BERNSTEIN, P.L.C., 1950 ROLAND CLARKE PLACE, RESTON, VA, 20191, US

(73) Assignee: PANASONIC CORPORATION, Osaka (JP)

(21) Appl. No.: 12/299,986

(22) PCT Filed: May 9, 2007
(86) PCT No.: PCT/JP2007/059580

§ 371 Date: Jan. 16, 2009

(30) Foreign Application Priority Data
May 10, 2006 (JP) 2006-131851

(51) Int. Cl. G10L 19/08; G10L 19/12

(52) U.S. Cl. 704/223; 704/219; 704/E19.026

(57) ABSTRACT

Provided is a voice encoding device for acquiring a satisfactory sound quality by making sufficient use of a tendency according to the noisiness or noiselessness of an input signal to be encoded. In this voice encoding device, a weight adding unit (206) in a searching loop (204) of a fixed code note searching unit (202) uses a function calculated from a code vector synthesized with a target to be encoded and spectrum enveloping information, as a calculated value to become the searching reference of the code vector stored in a fixed code note, and adds the weight according to the pulse number to form the code vector, to that calculated value.

### TECHNICAL FIELD

The present invention relates to a speech encoding apparatus and speech encoding method for performing a fixed codebook search.

### BACKGROUND ART

In mobile communication, compression encoding digital information about speech and images is essential for efficient use of transmission bands. Here, speech codec (encoding and decoding) techniques widely used in mobile phones are greatly expected, and further improvement of sound quality is demanded for conventional high-efficiency coding of high compression performance.

The performance of speech coding techniques, which has improved significantly by the basic scheme “CELP (Code Excited Linear Prediction),” modeling the vocal system of speech and adopting vector quantization skillfully, is further improved by fixed excitation techniques using a small number of pulses, such as the algebraic codebook disclosed in Non-Patent Document 1. Further, there is a technique for realizing higher sound quality by encoding that is applicable to a noise level and voiced or unvoiced speech.

As such a technique, Patent Document 1 discloses calculating the coding distortion of a noisy code vector and multiplying the calculation result by a fixed weighting value according to the noise level, while calculating the coding distortion of a non-noisy excitation vector and multiplying the calculation result by a fixed weighting value according to the noise level, and selecting an excitation code associated with the multiplication result of the lower value, to perform encoding using a CELP fixed excitation codebook.

A non-noisy (pulsive) code vector tends to have a shorter distance with the input signal to be encoded than a noisy code vector and is more likely to be selected whereby the sound quality of the acquired synthesis sound is pulsive which degrades subjective sound quality. However, Patent Document 1 discloses providing two separate noisy and non-noisy codebooks and multiplying a weight according to the distance calculation results in the two codebooks (i.e., multiplying the distance by respective weights), such that the non-noisy code vector is likely to be selected. By this means, it is possible to encode noisy input speech and improve the sound quality of decoded synthesis speech.

Patent Document 1: Japanese Patent Application Laid-Open No. 3404016

Non-Patent Document 1: Salami, Laflamme, Adoul, “8 kbit/s ACELP Coding of Speech with 10 ms Speech-Frame: a Candidate for CCITT Standardization,” IEEE Proc. ICASSP94, pp. II-97n

### DISCLOSURE OF INVENTION

### Problem to be Solved by the Invention

However, the technique of above Patent Document 1 fails to expressly disclose the measurement of noise level, and, consequently, adequate weighting is difficult to perform for higher performance. Therefore, although Patent Document 1 discloses multiplying a more adequate weight using an “evaluation weight determining section,” which is not disclosed sufficiently either, and, consequently, it is unclear how to improve performance.

Further, according to the technique of above Patent Document 1, a distance calculation result is weighted by multiplication, and the multiplied weight is not influenced by the absolute value of the distance. This means that the same weight is multiplied whether the distance is long or short. That is, a trend of noise level and non-noise level of an input signal to be encoded is not utilized sufficiently.

It is therefore an object of the present invention to provide a speech encoding apparatus and speech encoding method for sufficiently utilizing a trend of noise level and non-noise level of an input signal to be encoded and producing good sound quality.

### Means for Solving the Problem

The speech encoding apparatus of the present invention employs a configuration having: a first encoding section that encodes vocal tract information of an input speech signal into spectrum envelope information; a second encoding section that encodes excitation information in the input speech signal using excitation vectors stored in an adaptive codebook and a fixed codebook; and a searching section that searches the excitation vector stored in the fixed codebook, and in which the searching section includes a weighting section that performs weighting for a calculation value that serves as a reference in the search according to the number of pulses forming the excitation vectors.

The speech encoding method of the present invention includes: a first encoding step of encoding vocal tract information of an input speech signal into spectrum envelope information; a second encoding step of encoding excitation information in the input speech signal using excitation vectors stored in an adaptive codebook and a fixed codebook; and a searching step of searching the excitation vector stored in the fixed codebook, and in which the searching step performs weighting for a calculation value that serves as a reference in the search according to the number of pulses forming the excitation vectors.

### ADVANTAGEOUS EFFECT OF THE INVENTION

According to the present invention, it is possible to sufficiently utilize a trend of noise level and non-noise level of an input signal to be encoded and producing good sound quality.

### BRIEF DESCRIPTION OF DRAWINGS

FIG. 1 is a block diagram showing a configuration of a CELP encoding apparatus according to an embodiment of the preset invention;

FIG. 2 is a block diagram showing a configuration inside the distortion minimizing section shown in FIG. 1;

FIG. 3 is a flowchart showing a series of steps of processing using two search loops; and

FIG. 4 is a flowchart showing a series of steps of processing using two search loops.

### BEST MODE FOR CARRYING OUT THE INVENTION

An embodiment will be explained below in detail with reference to the accompanying drawings.

### Embodiment

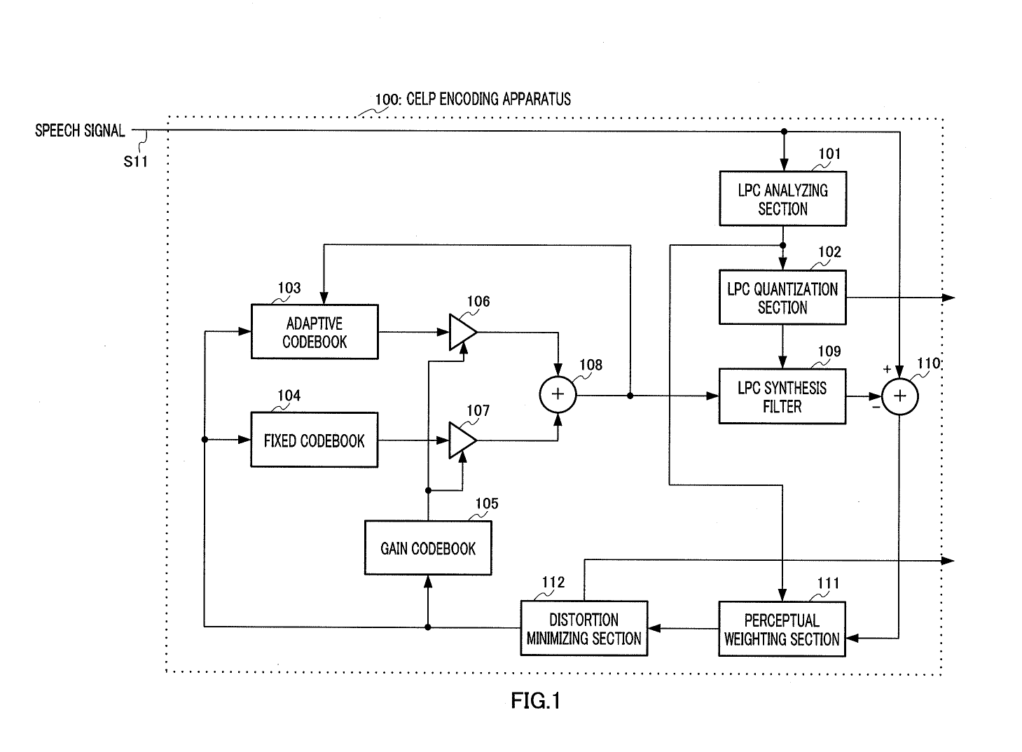

FIG. 1 is a block diagram showing the configuration of CELP encoding apparatus 100 according to an embodiment of the present invention. Given speech signal S11 comprised of vocal tract information and excitation information, this CELP encoding apparatus 100 encodes the voice tract information by finding a linear predictive coefficient (“LPC”) parameter and encodes the excitation information by finding an index specifying which speech model stored in advance to use, that is, by finding an index specifying what excitation vector (code vector) to generate in adaptive codebook 103 and fixed codebook 104.

To be more specific, the sections of CELP encoding apparatus 100 perform the following operations.

LPC analyzing section 101 performs a linear prediction analysis of speech signal S11, finds an LPC parameter that is spectrum envelope information and outputs it to LPC quantization section 102 and perceptual weighting section 111.

LPC quantization section 102 quantizes the LPC parameter acquired in LPC analyzing section 101, and outputs the acquired quantized LPC parameter to LPC synthesis filter 109 and an index of the quantized LPC parameter to outside CELP encoding section 100.

By the way, adaptive codebook 103 stores the past excitations used in LPC synthesis filter 109 and generates an excitation vector of one subframe from the stored excitations according to the adaptive codebook lag associated with the index designated from distortion minimizing section 112. This excitation vector is outputted to multiplier 106 as an adaptive codebook vector.

Fixed codebook 104 stores in advance a plurality of excitation vectors of a predetermined shape, and outputs an excitation vector associated with the index designated from distortion minimizing section 112, to multiplier 107, as a fixed codebook vector. Here, fixed codebook 104 refers to an algebraic codebook. In the following explanation, a configuration will be explained where two algebraic codebooks of respective numbers of pulses are used and weighting is performed by addition.

An algebraic excitation is adopted in many standard codecs and provides a small number of impulses that have a magnitude of 1 and that represent information only by their positions and polarities (i.e., + and −). For example, this is disclosed in chapter 5.3.1.9. of section 5.3 “CS-ACELP” and chapter 5.4.3.7 of section 5.4 “ACELP” in the ARIB standard “RCR STD-27K.”

Further, above adaptive codebook 103 is used to represent components of strong periodicity like voiced speech, while fixed codebook 104 is used to represent components of weak periodicity like white noise.

Gain codebook 105 generates and outputs a gain for the adaptive codebook vector that is outputted from adaptive codebook 103 (i.e., adaptive codebook gain) and a gain for the fixed codebook vector that is outputted from fixed codebook 104 (i.e., fixed codebook gain), to multipliers 106 and 107, respectively.

Multiplier 106 multiplies the adaptive codebook vector outputted from adaptive codebook 103 by the adaptive codebook gain outputted from gain codebook 105, and outputs the result to adder 108.

Multiplier 107 multiplies the fixed codebook vector outputted from fixed codebook 104 by the fixed codebook gain outputted from gain codebook 105, and outputs the result to adder 108.

Adder 108 adds the adaptive codebook vector outputted from multiplier 106 and the fixed codebook vector outputted from multiplier 107, and outputs the added excitation vector to LPC synthesis filter 109 as excitation.

LPC synthesis filter 109 generates a synthesis signal using a filter function including the quantized LPC parameter outputted from LPC quantization section 102 as the filter coefficient and the excitation vectors generated in adaptive codebook 103 and fixed codebook 104 as excitation, that is, using an LPC synthesis filter. This synthesis signal is outputted to adder 110.

Adder 110 finds an error signal by subtracting the synthesis signal generated in LPC synthesis filter 109 from speech signal S11 and outputs this error signal to perceptual weighting section 111. Here, this error signal corresponds to coding distortion.

Perceptual weighting section 111 performs perceptual-weighting for the coding distortion outputted from adder 110, and outputs the result to distortion minimizing section 112. Distortion minimizing section 112 finds the indexes of adaptive codebook 103, fixed codebook 104 and gain codebook 105, on a per subframe basis, such that the coding distortion outputted from perceptual weighting section 111 is minimized, and outputs these indexes to outside CELP encoding apparatus 100 as coding information. To be more specific, a synthesis signal is generated based on above-noted adaptive codebook 103 and fixed codebook 104, and a series of processing to find the coding distortion of this signal is under closed-loop control (feedback control). Further, distortion minimizing section 112 searches for these codebooks by variously changing the index designating each codebook, on a per subframe basis, and outputs the finally acquired indexes of these codebooks minimizing the coding distortion.

Further, the excitation in which the coding distortion is minimized, is fed back to adaptive codebook 103 on a per subframe basis. Adaptive codebook 103 updates stored excitations by this feedback.

A search method of fixed codebook 104 will be explained below. First, searching an excitation vector and finding a code are performed by searching for an excitation vector minimizing the coding distortion in following equation 1.

[1]

E=|x−(pHa+qHs)² (Equation 1)

where:

E: coding distortion;

x: encoding target;

p: gain of an adaptive codebook vector;

H: perceptual weighting synthesis filter;

a: adaptive codebook vector;

q: gain of a fixed codebook; and

a: fixed codebook vector

Generally, an adaptive codebook vector and a fixed codebook vector are searched for in open-loops (separate loops), finding the code of fixed codebook vector 104 is performed by searching for the fixed codebook vector minimizing the coding distortion shown in following equation 2.

[2]

y=x−pHa

E=|y−qHs|² (Equation 2)

where:

E: coding distortion

x: encoding target (perceptual weighted speech signal);

p: optimal gain of an adaptive codebook vector;

H: perceptual weighting synthesis filter;

a: adaptive codebook vector;

q: gain of a fixed codebook;

s: fixed codebook vector; and

y: target vector in a fixed codebook search

Here, gains p and q are determined after an excitation code is searched for, and, consequently, a search is performed using optimal gains. As a result, above equation 2 can be expressed by following equation 3.

$$\begin{matrix}( Equation 3 ) & \\ y = x - \frac{x \cdot Ha}{{\vert Ha \vert}^{2}} Ha & [ 3 ] \\ E = {\vert y - \frac{y \cdot Hs}{{\vert Hs \vert}^{2}} Hs \vert}^{2} & \end{matrix}$$

Further, minimizing this equation for distortion is equivalent to maximizing function C in following equation 4.

$$\begin{matrix}( Equation 4 ) & \\ C = \frac{{( yH \cdot s )}^{2}}{sHHs} & [ 4 ]\end{matrix}$$

Therefore, to search for an excitation comprised of a small number of pulses such as an excitation of an algebraic codebook, by calculating yH and HH in advance, it is possible to calculate the above function C with a small amount of calculations.

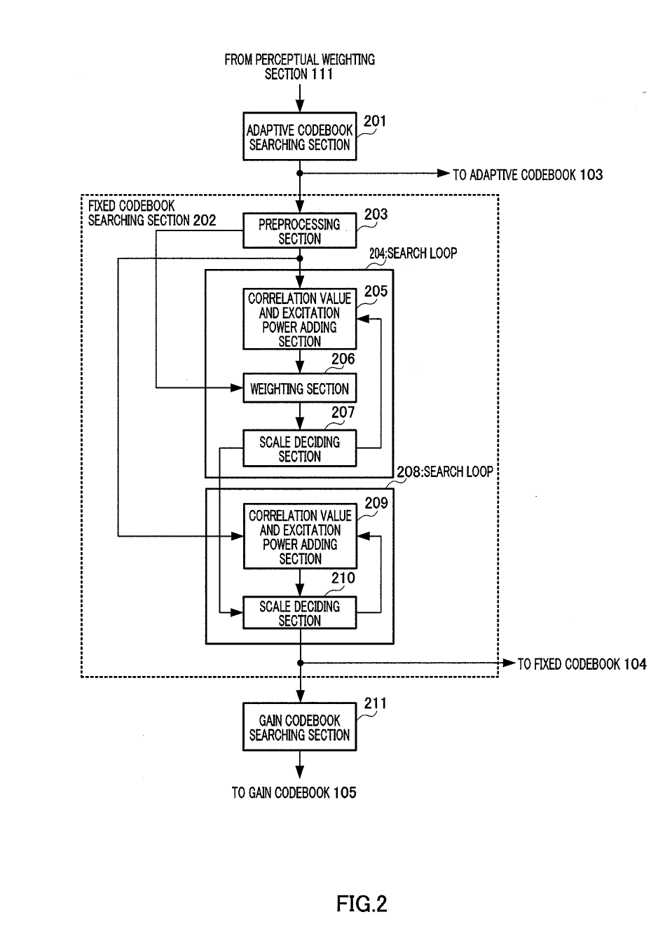

FIG. 2 is a block diagram showing the configuration inside distortion minimizing section 112 shown in FIG. 1. In FIG. 2, adaptive codebook searching section 201 searches for adaptive codebook 103 using the coding distortion subjected to perceptual weighting in perceptual weighting section 111. As a search result, the code of the adaptive codebook vector is outputted to preprocessing section 203 in fixed codebook searching section 202 and to adaptive codebook 103.

Preprocessing section 203 in fixed codebook searching section 202 calculates vector yH and matrix HH using the coefficient H of the synthesis filter in perceptual weighting section 111. yH is calculated by convoluting matrix H with reversed target vector y and reversing the result of the convolution. HH is calculated by multiplying the matrixes. Further, as shown in following equation 5, additional value g is calculated from the power of y and fixed value G to be added.

[5]

g=|y|²×G (Equation 5)

Further, preprocessing section 203 determines in advance the polarities (+ and −) of the pulses from the polarities of the elements of vector yH. To be more specific, the polarities of pulses that occur in respective positions are coordinated with the polarities of the values of yH in those positions, and the polarities of the yH values are stored in a different sequence. After the polarities in these positions are stored in the different sequence, the yH values are made the absolute values, that is, the polarities of the yH values are converted into positive values. Further, the HH values are converted in coordination with the stored polarities in those positions by multiplying the polarities. The calculated yH and HH are outputted to correlation value and excitation power adding sections 205 and 209 in search loops 204 and 208, and additional value g is outputted to weighting section 206.

Search loop 204 is configured with correlation value and excitation power adding section 205, weighting section 206 and scale deciding section 207, and search loop 208 is configured with correlation value and excitation power adding section 209 and scale deciding section 210.

In a case where the number of pulses is two, correlation value and excitation power adding section 205 calculates function C by adding the value of yH and the value of HH outputted from preprocessing section 203, and outputs the calculated function C to weighting section 206.

Weighting section 206 performs adding processing on function C using the additional value g shown in above equation 5, and outputs the function C after adding processing to scale deciding section 207.

Scale deciding section 207 compares the scales of the values of function C after adding processing in weighting section 206, and overwrites and stores the numerator and denominator of function C of the highest value. Further, scale deciding section 207 outputs function C of the maximum value in search loop 204 to scale deciding section 210 in search loop 208.

In a case where the number of pulses is three, in the same way as in correlation value and excitation power adding section 205 in search loop 204, correlation value and excitation power adding section 209 calculates function C by adding the values of yH and HH outputted from preprocessing section 203, and outputs the calculated function C to scale deciding section 210.

Scale deciding section 210 compares the scales of the values of function C outputted from correlation value and excitation power adding section 209 and outputted from scale deciding section 207 in search loop 204, and overwrites and stores the numerator and denominator of function C of the highest value. Further, scale deciding section 210 searches for the combination of pulse positions maximizing function C in search loop 208. Scale deciding section 210 combines the code of each pulse position and the code of the polarity of each pulse position to find the code of the fixed codebook vector, and outputs this code to fixed codebook 104 and gain codebook searching section 211.

Gain codebook searching section 211 searches for the gain codebook based on the code of the fixed codebook vector combining the code of each pulse position and the code of the polarity of each pulse position, and outputs the search result to gain codebook 105.

FIG's. 3 and 4 illustrate a series of steps of processing using above search loops 204 and 208 in detail. Further, the condition of an algebraic codebook is shown below.

| | |
|---|---|
| 1. the number of bits: | 13 bits |
| 2. unit of processing (subframe length): | 40 |
| 3. the number of pulses: | two or three |
| 4. additional fixed value: | G = −0.001 |

Under this condition, as an example, it is possible to design two separate algebraic codebooks shown below. (position candidates of codebook 0 (the number of pulses is two))

ici00 [20]={0, 2, 4, 6, 8, 10, 12, 14, 16, 18, 20, 22, 24, 26, 28, 30, 32, 34, 36, 38}
ici01 [20]={1, 3, 5, 7, 9, 11, 13, 15, 17, 19, 21, 23, 25, 27, 29, 31, 33, 35, 37, 39}
(position candidates of codebook 1 (the number of pulses is three))
ici10 [10]={0, 4, 8, 12, 16, 20, 24, 28, 32, 36}
ici11 [10]={2, 6, 10, 14, 18, 22, 26, 30, 34, 38}
ici12 [8]={1, 5, 11, 15, 21, 25, 31, 35}

The number of entries in the above two position candidates is (20×20×2×2)+(10×10×8×2×2×2)=1600+6400=8000<8192, that is, an algebraic codebook of 13 bits is provided.

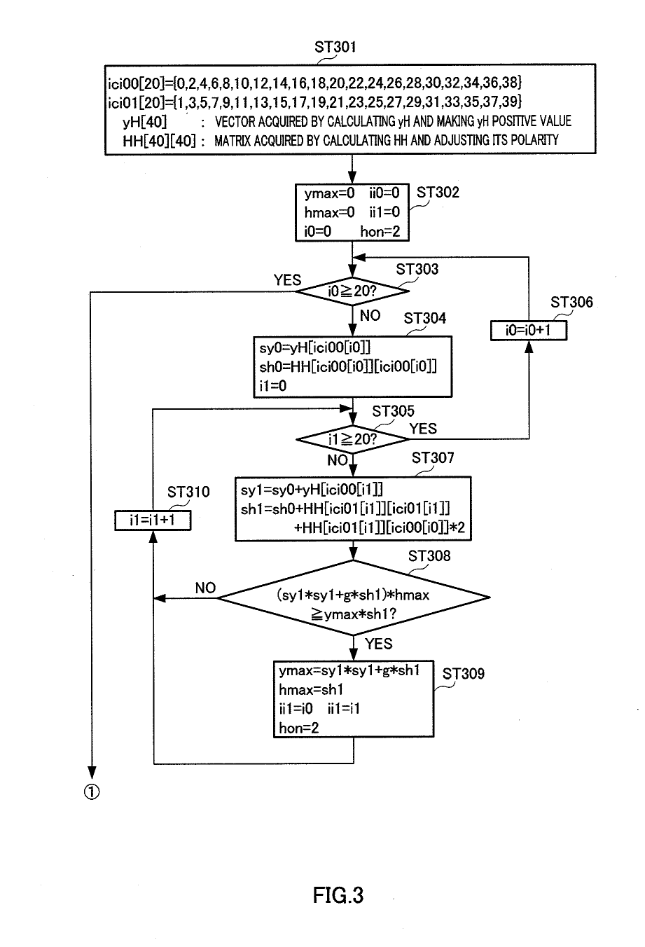

In FIG. 3, position candidates in codebook 0 (the number of pulses is two) are set in ST301, initialization is performed in ST302, and whether i0 is less than 20 is checked in ST303. If i0 is less than 20, the first pulse positions in codebook 0 are outputted to calculate the values using yH and HH as the correlation value sy0 and the power sh0 (ST304). This calculation is repeated until i0 reaches 20 (which is the number of pulse position candidates) (ST303 to ST306). Further, in ST 302 to ST309, codebook search processing is performed using two pulses.

Further, when i0 is less than 20, if i1 is less than 20, processing in ST305 to ST310 are repeated. In this processing, as for the calculation of a given i0, the second pulse positions in codebook 0 are outputted to calculate the values of yH and HH, and correlation value sy0 and power sh0 are added to these calculated values, respectively, to calculate correlation value sy1 and power sh1 (ST307). The function C are compared using correlation value sy1 and the value adding additional value g to power sh1 (ST308), and the numerator and denominator of function C of the higher value are stored (ST309). This calculation is repeated until i1 reaches 20 (ST305 to ST310).

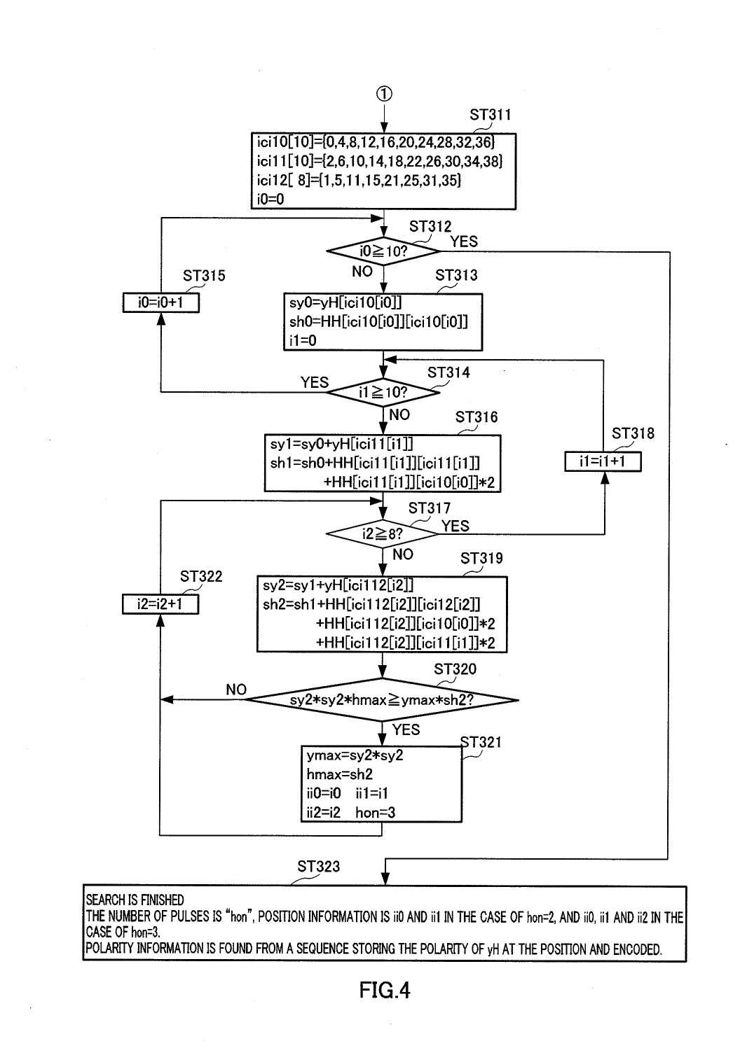

When i0 and i1 are equal to or greater than 20, the flow proceeds to ST311 in FIG. 4, in which position candidates in codebook 1 (the number of pulses is three) are set. Further, after ST310, codebook search processing is performed using three pulses.

Whether i0 is less than 10 is checked in ST312, and, if i0 is less than 10, the first pulse positions are outputted to calculate the values using yH and HH as the correlation value sy0 and the power sh0 (ST313). This calculation is repeated until i0 reaches 10 (which is the number of pulse position candidates) (ST312 to ST315).

Further, when i0 is less than 10, if i1 is less than 10, processing in ST314 to ST318 are repeated. In this processing, as for the calculation of a given i0, the second pulse positions in codebook 1 are outputted to calculate the values of yH and HH, and correlation value sy0 and power sh0 are added to these calculated values, respectively, to calculate correlation value sy1 and power sh1 (ST316). However, in ST317 in repeated processing in ST314 to ST318, if i2 is less than 8, processing in ST317 to ST322 are repeated.

In this processing, as for the calculation of a given i2, the third pulse positions in codebook 1 are outputted to calculate the values of yH and HH, and correlation value sy1 and power sh1 are added to these calculated values, respectively, to calculate correlation value sy2 and power sh2 (ST319). Function C of the maximum value comprised of the numerator and denominator in ST309 and the value of function C comprised of correlation value sy2 and power sh2 are compared (ST320), and the numerator and denominator of function C of the higher value are stored (ST321). This calculation is repeated until i2 reaches 8 (the number of pulse position candidates) (ST317 to ST322). In ST320, by the influence of additional value g, the function C for three pulses is likely to be selected rather than the function C for two pulses.

If both i0 and i1 are equal to or greater than 10 and i2 is equal to or greater than 8, search process is finished in ST323.

As described above, it is possible to realize weighting based on a clear reference of “the number of pulses.” Further, adding processing is adopted for the method of weighting, and, consequently, when the difference between an input signal and a target vector to be encoded is significant (i.e., when a target vector is unvoiced or noisy with dispersed energy), weighting has relatively a significant meaning, and, when the difference is insignificant (i.e., when a target vector is voiced with concentrated energy), weighting has relatively an insignificant meaning. Therefore, synthesized sound of higher quality can be acquired. The reason is qualitatively shown below.

If a target vector is voiced (i.e., non-noisy), cases are likely to occur where the scales of function values as a reference of selection are high and low. In this case, it is preferable to select an excitation vector by means of only the scales of the function values. In the present invention, adding processing of a fixed value does not cause large changes, so that an excitation vector is selected by means of the only scales of function values.

By contrast, if an input is unvoiced (i.e., noisy), all function values become low. In this case, it is preferable to select an excitation vector of a greater number of pulses. In the present invention, adding processing of a fixed value has a relatively significant meaning, so that an excitation vector of a greater number of pulses is selected.

As described above, according to the present embodiment, good performance can be secured by performing weighting processing based on a clear measurement of the number of pulses. Further, adding processing is adopted for the method of weighting, and, consequently, when the function value is high, weighting has a relatively significant meaning, and, when the function value is low, weighting has a relatively insignificant meaning. Therefore, an excitation vector of a greater number of pulses can be selected in the unvoiced (i.e., noisy) part, so that it is possible to improve sound quality.

Further, although the effect of adding processing is particularly explained as the method of weighting of the present embodiment, it is equally effective to perform multiplication as the method of weighting. The reason is that, when the relevant part in FIG. 3 is changed as shown in following equation 6, it is possible to perform weighting based on a clear reference of the number of pulses.

Adding processing according to the invention of FIG. 3:

(sy1*sy1+g*sh1)*hmax≧ymax*sh1

In a case of multiplication processing:

(sy1*sy1*(1+G))*hmax≧ymax*sh1 (Equation 6)

Further, an example case has been explained with the present embodiment where a negative value is added in adding processing upon searching a codebook of a small number of pulses, it is obviously possible to acquire the same result by adding a positive value upon searching a codebook of a large number of pulses.

Further, although a case has been explained with the present embodiment where fixed codebook vectors of two pulses and three pulses are used, combinations of any numbers of pulses are possible. The reason is that the present invention does not depend on the number of pulses.

Further, although a case has been described with the present embodiment where two variations of the number of pulses are provided, other variations are possible. By making the value lower when the number of pulses is smaller, it is easier to implement the present embodiment. In this case, search processing is connected to the processing shown in FIG. 3. When the present inventor used one to five pulses for five separate fixed codebooks search in encoding and decoding experiments, the inventor finds that good performance is secured using the following values.

fixed value for one pulse −0.002
fixed value for two pulses −0.001
fixed value for three pulses −0.0007
fixed value for four pulses −0.0005
fixed value for five pulses correlated value and unnecessary

Further, although a case has been described with the present embodiment where separate codebooks are provided for different numbers of pulses, a case is possible where a single codebook accommodates fixed codebook vectors of varying numbers of pulses. The reason is that the adding processing of the present invention is performed for decision of function values, and, consequently, fixed codebook vectors of a determined number of pulses need not be accommodated in a single codebook. In association with this fact, although an algebraic codebook is used as an example of a fixed codebook in the present embodiment, it is obviously possible to adopt a conventional multipulse codebook and learning codebook for a ROM in which fixed codebook vectors are directly written. The reason is that the number of pulses of the multipulse codebook is equivalent to the number of pulses of the present invention, and, when the values of all fixed codebook vectors are determined, it is easily possible to extract and use information about the number of pulses such as information about the number of pulse of an average amplitude or more.

Further, although the present embodiment is applied to CELP, it is obviously possible to apply the present invention to a encoding and decoding method with a codebook storing the determined number of excitation vectors. The reason is that the feature of the present invention lies in a fixed codebook vector search, and does not depend on whether the spectrum envelope analysis method is LPC, FFT or filter bank.

Although a case has been described with the above embodiments as an example where the present invention is implemented with hardware, the present invention can be implemented with software.

Furthermore, each function block employed in the description of each of the aforementioned embodiments may typically be implemented as an LSI constituted by an integrated circuit. These may be individual chips or partially or totally contained on a single chip. “LSI” is adopted here but this may also be referred to as “IC,” “system LSI,” “super LSI,” or “ultra LSI” depending on differing extents of integration.

Further, the method of circuit integration is not limited to LSI's, and implementation using dedicated circuitry or general purpose processors is also possible. After LSI manufacture, utilization of an FPGA (Field Programmable Gate Array) or a reconfigurable processor where connections and settings of circuit cells in an LSI can be reconfigured is also possible.

Further, if integrated circuit technology comes out to replace LSI's as a result of the advancement of semiconductor technology or a derivative other technology, it is naturally also possible to carry out function block integration using this technology. Application of biotechnology is also possible.

Further, the adoptive codebook used in explanations of the present embodiment is also referred to as an “adoptive excitation codebook.” Further, a fixed codebook is also referred to as a “fixed excitation codebook.”

The disclosure of Japanese Patent Application No. 2006-131851, filed on May 10, 2006, including the specification, drawings and abstract, is incorporated herein by reference in its entirety.

### INDUSTRIAL APPLICABILITY

The speech encoding apparatus and speech encoding method according to the present invention sufficiently utilize a trend of noise level and non-noise level of an input signal to be encoded and produce good sound quality, and, for example, is applicable to mobile phones.

1. A speech encoding apparatus comprising:
a first encoding section that encodes vocal tract information of an input speech signal into spectrum envelope information;
a second encoding section that encodes excitation information in the input speech signal using excitation vectors stored in an adaptive codebook and a fixed codebook; and
a searching section that searches the excitation vector stored in the fixed codebook,
wherein the searching section comprises a weighting section that performs weighting for a calculation value that serves as a reference in the search according to the number of pulses forming the excitation vectors.

2. The speech encoding apparatus according to claim 1, wherein the weighting section performs weighting such that an excitation vector of a smaller number of pulses is unlikely to be selected.

3. The speech encoding apparatus according to claim 1, wherein the weighting section performs weighting by addition.

4. The speech encoding section according to claim 3, wherein the weighting section uses a cost function calculated from an excitation vector synthesizing a target to be encoded and the spectrum envelope information, as the calculation value which serves as the reference, and adds to the calculation values, a value acquired by multiplying a predetermined fixed value by a value multiplying power of the target and power of the synthesized excitation vector.

5. A speech encoding method comprising:
a first encoding step of encoding vocal tract information of an input speech signal into spectrum envelope information;
a second encoding step of encoding excitation information in the input speech signal using excitation vectors stored in an adaptive codebook and a fixed codebook; and
a searching step of searching the excitation vector stored in the fixed codebook,
wherein the searching step performs weighting for a calculation value that serves as a reference in the search according to the number of pulses forming the excitation vectors.
